(19) United States
(12) Patent Application Publication
(10) Pub. No.: US 2019/0316570 A1
(43) Pub. Date: Oct. 17, 2019

(54) KINETIC ENERGY CONVERSION DEVICE OF PUNCHING MACHINE

(71) Applicants: Yao-Lin WANG, Taichung City (TW); Chong-Ying WANG, Taichung City (TW); Shuo-Pang WANG, Taichung City (US)

(72) Inventors: Yao-Lin WANG, Taichung City (TW); Chong-Ying WANG, Taichung City (TW); Shuo-Pang WANG, Taichung City (US)

(21) Appl. No.: 15/954,077

(22) Filed: Apr. 16, 2018

(51) Int. Cl. F03G 3/08; B23Q 5/02

(52) U.S. Cl. CPC F03G 3/08; B26F 1/02; B23Q 5/02

(57) ABSTRACT

A kinetic energy conversion device of a punching machine includes a punching table, a power unit, an air compressor, a clutch, a gas storage tank, a pressure detector and a generator. The power unit, the air compressor, the clutch, the gas storage tank, the pressure detector, and the generator are all disposed on the punching table. The power unit drives the clutch, air compressor, and generator to generate electrical power and high pressure gas. Therefore, the air compressor can operate without using additional energy. Compared with conventional punching equipment and the air compressor externally disposed and connected to the punching equipment, a large amount of electricity cost can be saved, achieving a power saving effect.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates generally to punching equipment, and more particularly to an innovative structure of a punching machine having a kinetic energy conversion device.

### 2. Description of Related Art Including Information Disclosed Under 37 CFR 1.97 and 37 CFR 1.98

The conventional punching equipment mostly utilizes an air compressor to provide high pressure gas so as to drive the power required for the operation of the corresponding components. In practical use, a single air compressor is supplied to a plurality of punching machines in a factory. Air compressors with higher compression ratios are required to be used for different punching equipment set with different air pressures. This causes a cost burden. In addition, the air ducts of the air compressors between a large number of machines are intertwined, leading to disorderly arrangement of lines in the whole factory. This is not only prone to accidents, but also difficult to grasp the overall power load situation.

Moreover, compared with the punching equipment that is a distance from the air compressor, the problem of pressure decay is apt to occur. Therefore, the various mechanisms in the punching equipment often are actuated inaccurately due to insufficient pressure.

In addition, the operation of air compressors consumes a large amount of electricity. When added with other power-consuming equipment in modern factories, the overall power consumption is considerable. Therefore, in order to reduce the power consumption and overcome the shortcomings of conventional air compressors for supplying high-pressure gas, how to develop an innovative structure that is more ideal and pragmatic is actually expected by users, and is also a goal and direction through which relevant industry must work hard to break.

### BRIEF SUMMARY OF THE INVENTION

The main purpose of the present invention is to provide a kinetic energy conversion device of a punching machine. The technical problem to be solved is to make innovation and breakthrough in how to develop a new type of kinetic energy conversion device structure for a punching machine that is more ideal and practical.

The technical features of the present invention to solve the problem are mainly that the kinetic energy conversion device of the punching machine comprises a punching table; a power unit that is installed on the punching table; an air compressor installed on the punching table; a clutch which is coupled to and driven by a power unit through a first belt; the clutch is additionally coupled with a second belt and selectively drives the air compressor to transfer the kinetic energy of the power unit to the air compressor; a gas storage tank which is disposed on the punching table and connected to the air compressor and the power unit, respectively; the gas storage tank stores a high-pressure gas provided by the air compressor and supplies the high-pressure gas to the power unit; a pressure detector which is connected to the gas storage tank for detecting its internal pressure; the pressure detector is electrically connected to the clutch and controls its operation state; and a generator which is disposed on the punching table and is coupled to and driven by the power unit through a third belt to generate electrical power; the generator supplies the power required by the clutch, air compressor and the pressure detector that are all electrically connected to the generator.

### BRIEF DESCRIPTION OF THE SEVERAL VIEWS OF THE DRAWINGS

FIG. 1 is a perspective view of a preferred embodiment of the kinetic energy conversion device of a punching machine of the present invention.

FIG. 2 is the main component configuration diagram of the present invention.

FIG. 3 is a block diagram of the present invention.

### DETAILED DESCRIPTION OF THE INVENTION

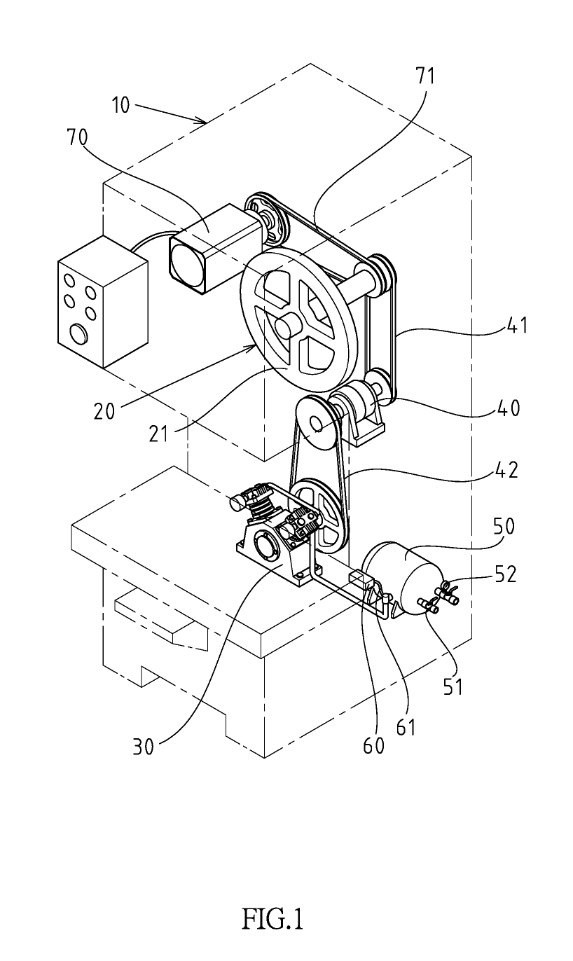

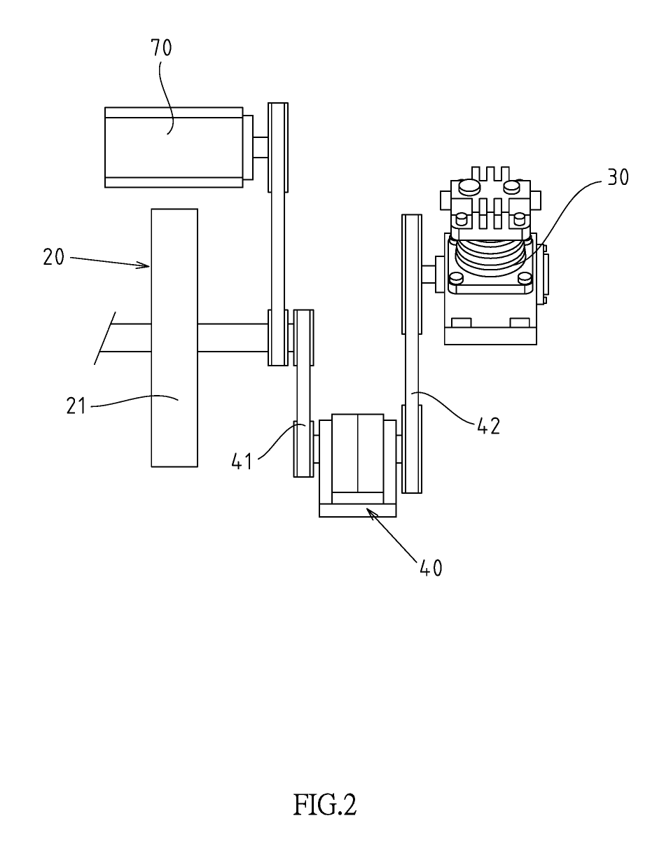

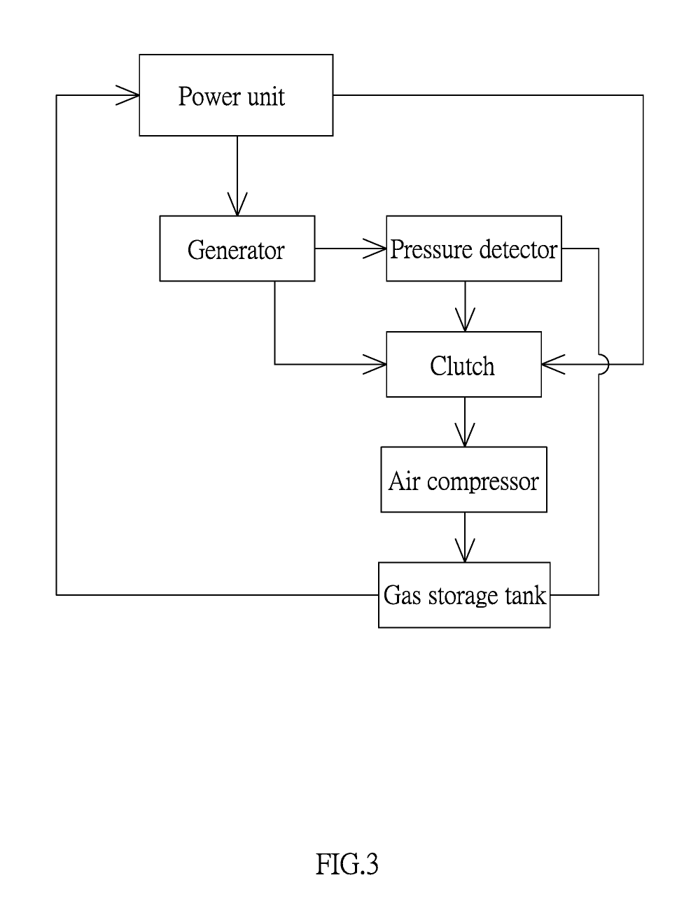

FIGS. 1 to 3 show the preferred embodiments of the kinetic energy conversion device of the punching machine of the present invention. However, these embodiments are only for illustration purposes, and the patent application is not limited by this structure. The kinetic energy conversion device of the punching machine comprises a punching table 10, a power unit 20, an air compressor 30, a clutch 40, a gas storage tank 50, a pressure detector 60 and a generator 70, wherein the power unit 20, the air compressor 30, the clutch 40, the gas storage tank 50, the pressure detector 60, and the generator 70 are all disposed on the punching table 10. As the punching table 10 is configured with the corresponding air compressor 30, the problems of disorderly arrangement of lines caused by the air ducts of the air compressors in the conventional punching equipment are solved, and the problem of pressure decay is prevented. In addition, a clutch 40 is coupled to and driven by a power unit 20 through a first belt 41, and the clutch 40 is additionally coupled with a second belt 42 and selectively drives the air compressor 30. A generator 70 is coupled to and driven by the power unit 20 through a third belt 71 to generate electrical power, and the generator 70 supplies the power required by the clutch 40 and the pressure detector 60 that are all electrically connected to the generator. Further, the clutch 40, the air compressor 30, and the generator 70 are linked together by belts, and they are independent components. In this way, when the heat energy is generated by the actuation of each component, the components can naturally dissipate heat through the air, so that the thermal energy continuously accumulated on one of the components to heat it up is prevented from the occurrence of overheating, damage, and abnormity of the components.

In this embodiment, the generator 70 converts the AC voltage into a DC voltage to supply to the clutch 40, and the air compressor 30 and the pressure detector 60. In addition, the power unit 20 is a flywheel 21 rotationally mounted on the punching table 10. When the power unit 20 drives the flywheel 21 to rotate, the flywheel 21 stores a large amount of inertial energy. Except for providing for the operation of the clutch 40 and the air compressor 30 so that the air compressor 30 can operate without using additional energy, the available large amount of mechanical kinetic energy can easily and continuously drive the generator 70 to rotate. Therefore, compared with the conventional punching equipment and the air compressor externally disposed and connected to the punching equipment (conventional air compressors use indoor power source directly, and its power consumption is considerable), this invention can save power costs by 30-40%, achieving the purpose of saving electricity costs.

The gas storage tank 50 is separately connected to the air compressor 30 and the power unit 20. The gas storage tank 50 stores a high-pressure gas provided by the air compressor 30 and supplies the high-pressure gas to the power unit 20. In this embodiment, the gas storage tank 50 further includes a pressure relief valve 51 and a pressure gauge 52, and the operator can check the pressure gauge 52 to know the pressure of the gas stored in the gas storage tank 50. If the pressure is too high, pressure relief procedure can be carried out through the pressure relief valve 51.

The pressure detector 60 is connected to the gas storage tank 50 for detecting its internal pressure, and the pressure detector 60 is electrically connected to the clutch 40 to control its operation state. The pressure detector 60 is communicating with the gas storage tank 50 by a copper tube 61.

With the above structural design and construction, the actuation of the present invention is described as follows. After the power unit 20 drives the flywheel 21 to rotate, the flywheel 21 drives the generator 70 through the third belt 71 to operate and generate electric energy accordingly. The input kinetic energy is converted into electrical energy, which is supplied to the clutch 40 and the pressure detector 60 for use. At this time, the flywheel 21 uses the first belt 41 again to drive the clutch 40 to rotate. Since the clutch 40 is in the idle state, kinetic energy is not transmitted to the air compressor 30. Then, when the pressure in the gas storage tank 50 drops to a set level (for example, the pressure less than 5 kg), the pressure detector 60 notifies the clutch 40 to operate, and the clutch 40 drives the air compressor 30 to operate and supplies the high-pressure gas to the gas storage tank 50 to convert the input kinetic energy into gas energy. Therefore, the air compressor can operate without using additional energy and achieve energy-saving effect. As the pressure in the gas storage tank 50 rises to reach the set pressure (for example, the pressure equal to 8 kg), the pressure detector 60 notifies the clutch 40 to stop driving the air compressor 30 to operate, so that the clutch 40 is in the idle state. At this time, the air compressor 30 no longer produces high pressure gas. Finally, the gas storage tank 50 inputs the high pressure gas and drives the power unit 20 to operate to convert the gas energy back into kinetic energy.

Therefore, in order to save energy, the operation of the power unit of the present invention is to drive the clutch, the air compressor and the generator to convert the mechanical kinetic energy into electrical energy and gas energy, and the gas energy can be further fed back to the power unit for the power unit to continuously operate and effectively reduce the power consumption of the power unit, thus achieving the effect that the gas energy and the kinetic energy are symbiotic with each other to enhance the efficiency of energy use.

Description of Efficacy:

The “kinetic energy conversion device of punching machine” disclosed by the present invention is mainly composed of a punching table, a power unit, an air compressor, a clutch, a gas storage tank, a pressure detector, and a generator, etc. Its structural type and technical features enable the present invention to achieve the following effects in comparison with the conventional structure proposed by the prior art: 1. Besides the generator is driven by the power unit to convert the mechanical kinetic energy into electric energy to directly supply to and the clutch and pressure detector as the power required for operation, the clutch is also driven by the power unit to transfer the mechanical kinetic energy to the air compressor for use. Therefore, the air compressor can be operated without using additional energy. Compared with conventional punching equipment and the air compressor externally disposed and connected to the punching equipment, a cost of electricity of 30-40% can be saved, achieving the power saving effect. 2. The clutch, the air compressor, and the generator are linked together by belts, and they are independent components. In this way, when the heat energy is generated by the actuation of each component, the components can naturally dissipate heat through the air, so that the thermal energy continuously accumulated on one of the components to heat it up is prevented from the occurrence of overheating, damage, and abnormity of the components. 3. The punching table is configured with the corresponding air compressor, which solves the problems of disorderly arrangement of lines caused by the air ducts of the air compressors in the conventional punching equipment are solved, and prevent the problem of pressure decay. 4. The operation of the power unit of the present invention is to drive the clutch, the air compressor and the generator to convert the mechanical kinetic energy into electrical energy and gas energy, and the gas energy can be further fed back to the power unit for the power unit to continuously operate and effectively reduce the power consumption of the power unit, thus achieving the effect that the gas energy and the kinetic energy are symbiotic with each other to enhance the efficiency of energy use.

We claim:

1. A kinetic energy conversion device of a punching machine comprises:
a punching table;
a power unit disposed on the punching table;
an air compressor disposed on the punching table;
a clutch which is coupled to and driven by a power unit through a first belt; the clutch is additionally coupled with a second belt and selectively drives the air compressor to transfer the kinetic energy of the power unit to the air compressor;
a gas storage tank which is disposed on the punching table and connected to the air compressor and the power unit, respectively; the gas storage tank stores a high-pressure gas provided by the air compressor and supplies the high-pressure gas to the power unit;
a pressure detector which is connected to the gas storage tank for detecting its internal pressure; the pressure detector is electrically connected to the clutch and controls its operation state; and
a generator which is disposed on the punching table and is coupled to and driven by the power unit through a third belt to generate electrical power; the generator supplies the power required by the clutch, air compressor and the pressure detector that are all electrically connected to the generator.

2. The device defined in claim 1, wherein the generator converts AC voltage into DC voltage.

3. The device defined in claim 2, wherein the power unit is a flywheel that is rotationally mounted on the punching table.

4. The device defined in claim 3, wherein the pressure detector is communicating with the gas storage tank by a copper pipe.
